(19) United States
(12) Patent Application Publication
(10) Pub. No.: US 2020/0282558 A1
(43) Pub. Date: Sep. 10, 2020

(54) SYSTEM AND METHOD FOR CONTROLLING A ROBOT WITH TORQUE-CONTROLLABLE ACTUATORS

(71) Applicant: LinkDyn Robotics Inc., Austin, TX (US)

(72) Inventors: Bongsu Kim, Austin, TX (US); James Douglas DeBacker, JR., Austin, TX (US); Jovita Chidimma Ezeokafor, Austin, TX (US)

(21) Appl. No.: 16/811,119

(22) Filed: Mar. 6, 2020

Related U.S. Application Data
(60) Provisional application No. 62/814,972, filed on Mar. 7, 2019.

(51) Int. Cl. B25J 9/16; B25J 19/02; B25J 19/06; B25J 9/00; B25J 11/00

(52) U.S. Cl. CPC B25J 9/1633; B25J 9/1666; B25J 9/1607; B25J 11/005; B25J 19/02; B25J 19/068; B25J 9/0081; B25J 9/1651

(57) ABSTRACT

A system having a control system and a robot equipped or configured with torque-controllable actuators. In some cases, the system may be a robotic arm and/or system configured to allow for precisely controlled force-based responses and contact with environmental or physical objects. The robotic arm may be configured to operator in close proximity to humans or operators as well as other objects to perform various industrial tasks without risk of injury or damage as well as to be usable to provide for safe and effective virtual reality simulations.

### CROSS-REFERENCE TO RELATED APPLICATION(S)

This application claims priority to U.S. Provisional Application No. 62/814,972 filed on Mar. 7, 2019 and entitled “SYSTEM AND METHOD FOR GENERATING FORCE FEEDBACK FOR VIRTUAL REALITY,” which is incorporated herein by reference in its entirety.

### BACKGROUND

Today, there is increasing demand for collaborative robotic applications and system that require precisely controlled force-based interactions. For example, force-sensitive industrial tasks such as sanding and polishing increasingly rely on machines and automated systems. However, most existing robotic systems provide inadequate support and responses to force-based interactions, are highly expensive, and require operator free work environments.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example robotic system with torque-controllable actuators according to some implementations.

FIG. 2 illustrates an example block diagram of the robotic system of FIG. 1 according to some implementations.

FIG. 3 illustrates an example control diagram for the robotic system of FIG. 1 according to some implementations.

FIG. 4 illustrates an example pictorial diagram of an impedance neutral position transition along a motion path according to some implementations.

FIG. 5 illustrates an example pictorial diagram of a model associated with the end-effector position and an impedance neutral position according to some implementations.

FIG. 6 illustrates an example diagram illustrating an example process for determining a target point associated with a motion path or trajectory as according to some implementations.

FIG. 7 illustrates a pictorial diagram associated with the process of FIG. 6 according to some implementations.

FIG. 8 illustrates an example pictorial diagram of a robotic system with torque-controllable actuators controlling motion of an end-effector based on an impedance neutral position and an input impedance according to some implementations.

FIG. 9 illustrates an example actuator torque controller according to some implementations.

FIG. 10 illustrates an example acceleration estimator according to some implementations.

FIG. 11 illustrates an example pictorial diagram of a user utilizing the robotic system with respect to a virtual or mixed reality environment according to some implementations.

FIG. 12 illustrates an example architecture associated with the robotic system of FIG. 1 according to some implementations.

FIG. 13 illustrates an example architecture associated with the robotic system of FIG. 11 according to some implementations.

FIG. 14 illustrates an example diagram illustrating an example process for determining feedback force associated with a virtual or mixed reality environment according to some implementations.

FIG. 15 illustrates another example pictorial diagram of a user utilizing the robotic system with respect to a virtual or mixed reality environment according to some implementations.

### DETAILED DESCRIPTION

Described herein are implementations and embodiments of a system comprising a control system and a robot equipped or configured with torque-controllable actuators. In some cases, the system discussed herein may be a robotic arm and/or system configured to allow for precisely controlled force-based responses and contact with environmental or physical objects. For example, the robotic arm may be configured to operate in close proximity to humans or operators as well as other objects to perform various industrial tasks without risk of injury or damage. In other examples, the robotic arm may be usable to provide for safe and effective virtual reality simulations. For instance, the robotic arm may be configured to convey and replicate real life force-based interaction with virtual and/or remote objects. Thus, unlike conventional force based robotic systems that are designed to follow position commands (no matter the forces exerted against the robot in the physical environment), the system discussed herein is configured to respond and interact with external forces encountered during operations.

The compliant and adaptive nature of the precision force control of the system discussed herein, allows the robot to perform a variety of force-oriented industrial tasks such as surface treatment or assembly by force without expensive force sensors or complicated programing processes. For example, the robot arm may perform tasks such as sanding, polishing, and buffing of curved surfaces with precise force that directly affects the quality of outcome. Force control also enables more intuitive robot programming methods such as teach-and-follow programing, in which a user guides the robot by hand to record and save position and orientation trajectories that the robot can play back with a user-defined impedance. Thus, the robot arm and system discussed herein may automate assembly and manipulation of objects in unstructured environments where human-like compliant and adaptive behaviors work more effectively than conventional rigid preprogrammed robot behaviors.

In some implementations, the robotic system may include a robotic arm that includes one or more torque-control actuators. The torque-control actuators may act as joints coupling between the various segments of the robotic arm allowing the arm to move with any number of degrees of motion or freedom (including systems having six degrees of freedom). In some cases, the robotic arm may be configured such that the actuators of each joint generate rotary motion and torque which may be propagated throughout the structure of the arm to yield translational and rotational motion at the robot end-effector. It should be understood, that with higher numbers of joints, torque-control actuators, and rotational sources, more degrees of torque or force may be generated at the end-effector, such as up to a three degrees of torque and three degrees of force.

In some cases, a control system may be electively and/or communicatively coupled to the robotic arm such that the control system may generate torque commands for each of the joints and/or receive feedback from each joint. In some instances, the control system may be configured to allow a user or operator of the system to configure a behavior (e.g., an impedance and motion) of the robotic arm and to provide a reactive feedback control loop or network to compensate for force-interactions within the physical and/or virtual environment. For example, the robotic control system may include a task planner, a robotic force controller and one or more proportional-derivate (PD) controller (e.g., a PD controller for each joint).

In one illustrative example, the control system may cause the operations of the arm to mimic or replicate the motion of a virtual spring having an impedance neutral point being moved or pulled along desired path. Thus, in this example, an operator may input a desired motion, such as a position-based task (e.g., a pick and place operation), and an impedance (or stiffness, dampening coefficient, etc.) associated with the virtual spring. The task planner may then convert the desired motion and the impedance into a current force command or task based at least in part on the current impedance neutral point, the desired impedance, and the position and/or orientation of the end-effector (or, in some implementations, the current position of each joint). In some cases, the task planner may determine the current force command or task for a defined behavior of the end-effector position and orientation at a given period of time. The robotic force controller may then generate a current torque command or task for the torque-controlled actuators of the joints based at least in part on the current force command or task and a feedforward torque representative of forces caused by the robotic system and operations (e.g., the weight of the robotic arm).

In this example, if an object obstructs the motion path of the robotic arm, the distance between the impedance neutral point and the actual position of the end-effector increases (as the end-effector is obstructed). As the distance between the impedance neutral point and the actual position of the end-effector increases, the impedance (e.g., force of the spring) is increased, resulting in increasing current force commands, which results in either the obstruction being gently pushed out of the way or the impedance exceeding a safely limit (which may also be set by an operator) and the task planner halting the movement of the impedance neutral point. In the example, when the safely limit is exceeded, once the obstruction is removed, the robotic arm will again attempt to converge with the impedance neutral point (with a force that decreases as the end-effector nears the impedance neutral point). Similarly, if the end-effector is pushed or moved off of the motion path, the distance between the impedance neutral point and the actual position of the end-effector increases and the orientation between the impedance neutral point and the actual position of the end-effector may change. In this example, the impedance controller 322 will adjust the current force command based on the relative positions between the impedance neutral point and the actual position of the end-effector causing the end-effector to close in on or chase the impedance neutral point. In this manner, the amount of force exerted on an obstruction (e.g., object or individual) may be both minor (e.g., less than 10 Newtons) upon contact and maintained below a desired safely level (such as 50 Newtons).

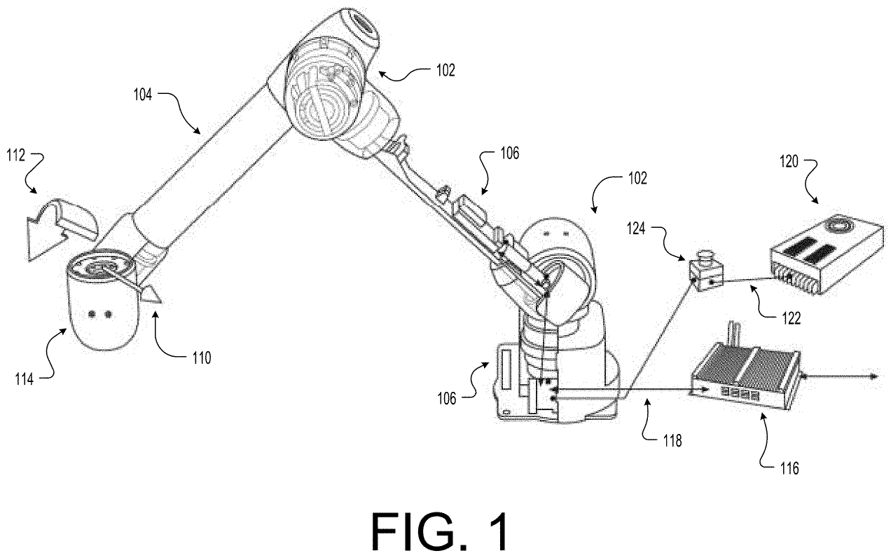

FIG. 1 illustrates an example a robotic system 100 with torque-control actuators, such as actuators 102, according to some implementations. In the illustrated example, the robotic system 100 includes a robotic arm 104 that includes at least one torque-control actuator 102 at each joint location to allow the arm 104 to experience a corresponding number of degrees of torque or force (e.g., each actuator 102 allows for an additional degree). The torque-control actuators may be electronically and/or communicatively coupled to actuator control systems 106. Together, the actuator control systems 106 and the actuators 102 allow the torque control actuators 102 to have the capability to precisely control output torque and have high backdrivability characteristics. For example, at each joint, the actuators 102 may generate rotary motion and torque that may be propagated through the structure of the robotic arm 104 to yield translational motion, generally indicated by 110, and rotational motion, generally indicated by 112, at the robot end-effector 114. Thus, with higher numbers of joints and rotational sources (e.g., actuators 102), additional degrees of torque or force may be generated at the end-effector 114. In some cases, the joints and accuators 102 may be interconnected with structural components (e.g. carbon-fiber tubes) which comprise the body and shape of the robotic arm 104.

In addition to the actuator control system 106, the torque control actuators 102 and/or the actuator control system 106 may be electrically and/or communicatively coupled to a robotic controller or system 116. In the current example, each individual actuator control system 106 may be serially connected to the robotic control system 116 using, for instance, network communication wires, generally indicated by 118, and to a power supply 120, via power wires, generally indicated by 122. In some cases, the wires 118 and 122 may be mounted to the body of the robotic arm 104 and enclosed by a cover or exterior for protection. Thus, the wires 118 and 122 may be routed through internal channels of the robotic arm 104 for protection as well as aesthetic purposes. The power supply 120 may be a direct current supply that provides a power signal to the actuator control systems 106. In some cases, for additional safely, an emergency switch 124 may be coupled between the actuator control systems 106 and the power supply 120 to provide system 100 operators an accessible shutoff point.

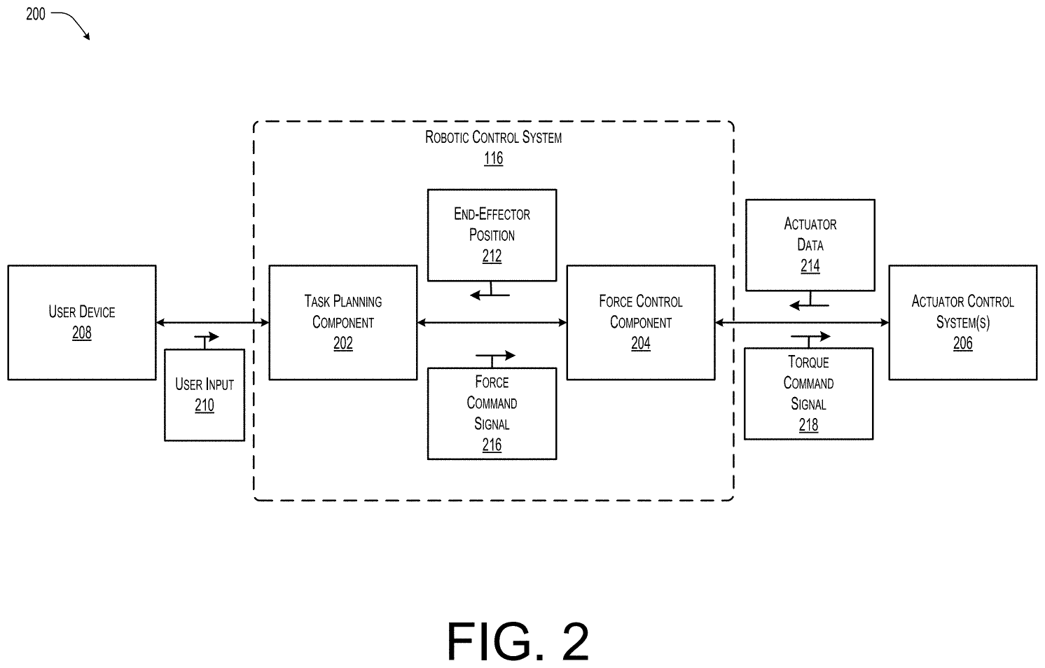

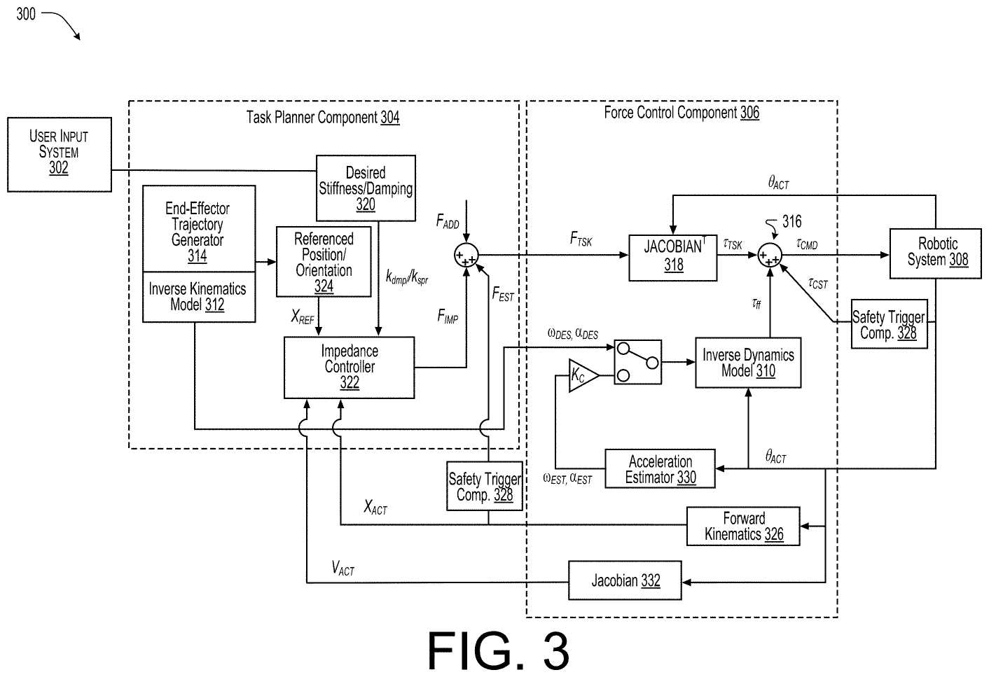

As will be discussed in more detail below with respect to FIGS. 2 and 3, the robotic control system 116 may include a task planner component configured to receive user inputs with respect to a trajectory or motion path of the robotic arm 104 or the end-effector 114 as well as a desired impedance, damping, or stiffness. The task planner component may also receive feedback from each of the torque-control actuators 102 and/or the actuator control system 106 and generate a force task command from the various inputs. The robotic control system 116 may also include a robotic force controller component configured to receive the force command as well as a data representative of an end-effector position from the torque-control actuators 102 and/or the actuator control system 106. In some cases, the robotic force controller component may generate a feedforward torque based at least in part on the data representative of an end-effector position (e.g., joint angles, velocities, and accelerations) and then to generate one or more torque commands for the torque-control actuators 102 based on the force command and the feedforward torque. The robotic force controller component may then provide the one or more torque commands to the actuator control system 106 for controlling the movement of the robotic arm 104.

FIG. 2 illustrates an example block diagram 200 of the robotic control system 116 of FIG. 1 according to some implementations. As discussed above, the robotic control system 116 may include a task planning component 202 and a force control component 204 communicatively coupled to an actuator control system 206. In some cases, the robotic control system 116 may also be coupled to user input device 208, such as a personal computer or portable electronic device, for receiving user inputs 210. The user inputs 210 may include a desired motion, such as a motion path and one or more tasks along the path and an impedance (or stiffness, dampening coefficient, etc.) associated with the virtual spring.

The task planning component 202 may be configured to receive the user inputs 210 together with end-effector position 212 from either or both of the force control component 204 and/or the actuator control systems 206. For example, in some implementations, the actuator control systems 206 may provide the end-effector position 212 to the task planning component 202 directly while in other cases, the actuator control system 206 may output actuator data 214, such as angular position, velocity, acceleration, etc. which is usable by the task planning component 204 to determine the end-effector position 212. In another implementation, illustrated here, the actuator control systems 206 may provide the actuator data 214 to the force control component 204 and the force control component 204 may determine and provide the end-effector position 212 to the task planning component 202.

The task planning component 202 may generate based on the user input 210 (e.g., the impedance, motion path, and tasks) and the end-effector position 212 a next force command signal 216. For example, the task planning component 202 may determine a next force command 216 for each of a plurality of segments or periods of time as the robotic arm completes the assigned tasks. For instance, the task planning component 202 may determine for the segment of time a force command based on an impedance neutral point along the motion path and the end-effector position 212. In some cases, if the commanded force exceeds a predetermined threshold force (e.g., the virtual spring is stretched to far), the task planning component 202 may stop the progression of the impedance neutral point along the motion path and, in effect, cause the force commanded by the command signal 216 to be set to a maximum value (e.g., a command to limit the force of the arm until the obstruction is removed or the limited force as applied to the obstruction causes the obstruction to move).

The force control component 204 may receive the force command signal 216 as well as the actuator data 214 (e.g., the angular position, velocity, and acceleration of the end-effector) to determine a torque command signal 218 for execution by the actuator control systems 206. For example, the force control component 204 may determine a feedforward torque based on the position and orientation (or angular position) of the end-effector and either the actual velocity and acceleration or a desired velocity and acceleration when a desired trajectory is given from the task planner component 304. The force control component 204 may then generated a torque command signal 218 based at least in part on the feedforward torque and the force command signal 216. In some cases, the force control component 204 may generate a torque vector based on the position and orientation of the end-effector and the force command signal 216 and the torque command signal 218 may be determined based at least in part on the torque vector and the feedforward torque. In some specific examples, the force control component 204 may also base the torque command signal 218 on one or more torque safety vectors, such as to constrain the arms motion to a safe joint range thereby preventing damage to one or more of the torque-control actuators.

FIG. 3 illustrates an example control diagram 300 for the robotic system of FIG. 1 according to some implementations. As discussed above, the robotic control system may be configured to include a user input device or system 302 to allow a user to define an impedance, motion path, and one or more tasks for the robotic arm, a task planner component 304 to generate task-related workspace force, Fₜₛₖ, (e.g., the force command signal of FIG. 2) provided to a force control component 306. The force control component 306 may generate a control torque input, τ_{cmd}, (e.g., the torque command signal of FIG. 2) using the task-related workspace force, Fₜₛₖ, and provide to the torque-control actuators of the robotic system 308. In this manner, the robotic control system may be configured to generate soft and safe behaviors of the robotic arm while performing trajectory and position-based tasks, such as pick-and-place.

In the current example, the robotic control system 300 may utilize a robot dynamics model, represented as follows:

M(θ)α+C(θ, ω)+G(θ)=τ_{cmd}+τₑₓₜ

where, M, C, and G respectively represent inertia matrix, centrifugal and Coriolis force with other velocity related forces, and gravity force and θ, ω, and α respectively represent angular position, velocity, and acceleration of robotic joints. In this example, it should also be understood that τ_{cmd} is a vector of commanded torque values associated with the robot joints and may be used as a control input to the target robotic system and τₑₓₜ is a vector of torque values that are caused by external forces applied to the robotic system. Since the robotic system 308, discussed herein, is equipped with torque-controllable actuators, the actuators may be regarded as pure torque sources, and the actuator dynamics may be ignored in the model equation above.

In the illustrated example, the control input may be received by the robotic system 308 as torque vector, τ_{cmd}, which when applied by the actuators produce an intended behavior. In the current example, the control input, τ_{cmd}, is utilized to generate a desired workspace impedance behavior of robot's end-effector, using the following equation:

τ_{cmd}=τ_{ff}+τₜₛₖ+τₑₛₜ

Thus, the control torque input, τ_{cmd}, may be determined based on a feedforward torque, τ_{ff}, to increase the overall fidelity of the robotic movement by compensating for at least a portion of the forces from the robot dynamics including robotic system's own weight. In this example, a torque vector, τ_{cst}, may also be used to determine the control torque input, τ_{cmd}, to improve overall safety by constraining joint angles to movement within a safe range.

τ_{ff}=M′(θ_{act})α_{des}+C′(θ_{act}, ω_{des})+G′(θ_{act})

As shown above, the feedforward torque in equation, τ_{ff}, may be determined using an inverse dynamics model 310 with an estimated robot inertia matrix, M′, estimated centrifugal and Coriolis force with velocity related force, C′, and estimated gravity force, G′. The actual angular position, θ_{act}, desired velocity, ω_{des}, and desired acceleration, α_{des}, of robotic joints may be used as the input parameters to the inverse dynamics model 310. For example, the actual angular position, θ_{act}, may be received from one or more sensors associated with the robotic system 308 and the desired velocity, ω_{des}, and the desired acceleration, α_{des}, may, in some cases, be determined using an inverse kinematics model 312 with a given end-effector trajectory position generated by the end-effector trajectory generator 314 and/or from an acceleration estimator 330.

Using the feedforward torque, τ_{ff}, and the task-related workspace force, Fₜₛₖ, force control component 306 associated with the robotic system 308 with torque-controllable actuators may generate, at a Jacobian matrix component 318, generate a torque vector, Tₜₛₖ, using the following equation:

τₜₛₖ=J(θ)^{T}Fₜₛₖ

In the current example, to generate the task-related workspace force, Fₜₛₖ, a torque vector, τₜₛₖ, is converted, at a Jacobian matrix component 318, from the force by the transpose of Jacobian matrix, J(θ), as shown in equation above and may be added at 316 to the control torque input, τ_{cmd}, provided to the actuators of the robotic system 308. In the current example, the task-related workspace force, Fₜₛₖ, may be determined based on a force, Fᵢₘₚ, discussed below, an established force, Fₑₛₜ, from a safety trigger component 328, and any additional force, F_{add}, such as any force to compensate for gravity acting on an object being held and/or moved by the end-effector.

In the task planner component 304, a reference position, X_{ref}, at robot's end-effector is calculated from an impedance-based trajectory generator 314 and then a spring-dampening force, Fᵢₘₚ, required for an end-effector to generate a spring-damping like impedance behavior may be determined by the impedance controller 322 as follows:

Fᵢₘₚ=kₛₚᵣ(X_{ref}−X_{act})−k_{dmp}V_{act}

where kₛₚᵣ and k_{dmp} are stiffness and damping matrices that may be input by the user via the user system 302 and/or determined by a desired stiffness/damping component 320 of the task planner component 304 based on the user input and V_{act} is the actual linear/angular velocities of the end-effector. V_{act} may be converted from the estimated joint velocity by a second Jacobian Matrix component 332 based on the actual angular position, θ_{act}, provided by the sensors of the robotic system 308. A reference position/orientation component 324 may also generate, a referenced position, X_{ref}, and an actual position, X_{act} of the end-effector may be determined by a forward kinematics component 326 based on the actual angular position, θ_{act}, provided by the sensors of the robotic system 308.

Using the above equation, the end-effector of the robotic system 308 acts as a spring-damper system with spring or impedance neutral position at X_{ref}. Trajectory control is done by updating the value of spring or impedance neutral position X_{ref}. The trajectory generator 314 and/or the referenced position/orientation component 324 of the task planner component 304 may generate a desired end-effector position at each control cycle (e.g. each segment or period of time) to update the spring or impedance neutral position. In some cases, the trajectory may be in the form of a workspace position and orientation of the end-effector without an inverse kinematics determination. In some cases, the inverse kinematics model 312 may be used to convert the reference frame for expressing the orientation of end-effector and to compensate for other adverse effects that may occur during execution of the trajectory by the robotic system 308.

Using the above referenced impedance-based trajectory control, the robotic system 308 is compliant to any interference from external disturbances (e.g., physical obstructions). However, the robotic system 308 with the impedance-based trajectory control may stop or otherwise halt movement in response to contact with an object in the external or physical environment. In some cases, the force output by the end-effector may increase as the trajectory progresses. In some cases, to prevent excessive force, an additional constraint representing a spring stretch as (X_{ref}−X_{act}) may be used as a first threshold value by various safety trigger components 328 to halt the progression of the target point (X_{ref}) when exceeded. Additionally, the impedance force, Fᵢₘₚ, following the above equation may be explicitly saturated at a maximum impedance.

For more compliant behaviors to a large amount of external disturbances, a process of trajectory recalculation may be added to the trajectory generator 314 of the task planner component 304. When the spring stretch (X_{ref}−X_{act}) is beyond a second threshold value, the spring neutral position, X_{ref}, is dragged to a new position close to the actual end-effector position. As a result of the combination of the force controller component 306 and the task planner component 304, the robotic system 308 with torque-controllable actuators may generate soft and safe behaviors while following trajectories to perform given tasks.

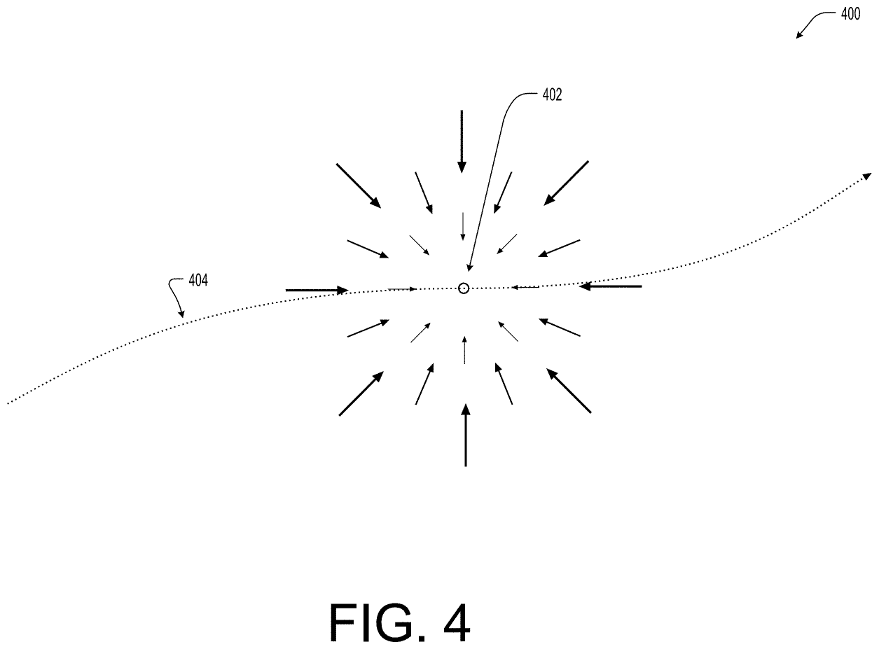

FIG. 4 illustrates an example pictorial diagram 400 of an impedance neutral position 402 transition along a trajectory 404 according to some implementations. As illustrated above, the task planner component may include a trajectory generator that may be used to generate the trajectory 404 and the impedance neutral position, X_{ref}, 402 for each cycle or segment of time. In some cases, the trajectory generator receives a desired end-effector position and orientation, with a desired movement speed and a desired impedance. The trajectory generator may the then generate a set of intermediate positions and orientation commands to send to an impedance controller of the task planner component on an iterative basis (e.g., during each segment of time). For example, given the end-effector target end point, as well as a current position, orientation, and velocity of the robotic end-effector as inputs: X_{act}, X_{tg}, V_{act}, v, kₛₚᵣ, k_{dmp}, where X_{act} is the actual position and orientation of the end-effector of the interested robotic system and X_{tg} is the target position and orientation of the end-effector. Additionally, V_{act} is the actual linear velocity and angular velocity of the end-effector, v is the desired movement speed of the end-effector, kₛₚᵣ, k_{dmp} are desired impedance parameters.

In the illustrated example, the output of the trajectory generator is X_{ref}[i], kₛₚᵣ, k_{dmp} where [i] is the element in the array of intermediate points, and X_{ref} is an intermediate spring's reference coordinate, as represented by the plurality of points associated with the trajectory 404. The impedance position may be modeled as a virtual spring around the impedance neutral position 402 in space, so the trajectory or trajectory 404 is modeled as a moving impedance neutral position 402 with the virtual spring attached to the end-effector, such that at various positions about the impedance neutral position 402 the end-effector experiences the force associated with the force field 406 about the impedance neutral position 402 as shown. Further it should be understood that as the impedance neutral position 402 transitions along the trajectory or motion path 404, the force field also adjusts again resulting in a physical output by the robotic system replicating an experience of the end-effector being pulled along the trajectory 404 by the impedance neutral position 402 via a coupled spring.

In one particular example, the array of intermediate points along the trajectory 404 may be generated by determining a straight line between the starting and ending positions, as well as a straight rotation between the starting and ending orientations or end-effector poses. Next, the task planning component generates for each segment of time or cycle an intermediate point using the starting point and directions based on a linear trajectory, a polynomial-based trajectory to minimize an overall jerk along the trajectory. For instance, the following 5th order minimum-jerk trajectory may be used:

C₅ₜₕ=(10(t/Tₛ)³−15(t/Tₛ)⁴+6(t/Tₛ)⁵)

where t is the intermediate time requested at each iteration and Tₛ is the time associated with the entire trajectory motion. In some cases, Tₛ may be determined based on the distance between the start and end points and the desired movement speed and C₅ₜₕ may be a coefficient between [0,1] which represents the 5th order minimum-jerk trajectory in the time domain. Thus, to generate the intermediate points, each point may be represented by the starting point plus the span between the starting and ending points multiplied by C₅ₜₕ as follows:

X_{ref}=Xₛₜₐᵣₜ+C₅ₜₕ(X_{tg}−Xₛₜₐᵣₜ)

In which Xₛₜₐᵣₜ is the starting robotic system position and orientation. Since t increments every loop iteration, the output of the trajectory generator is a set of intermediate points that act as the impedance neutral positions for the impedance controller of the task planner component.

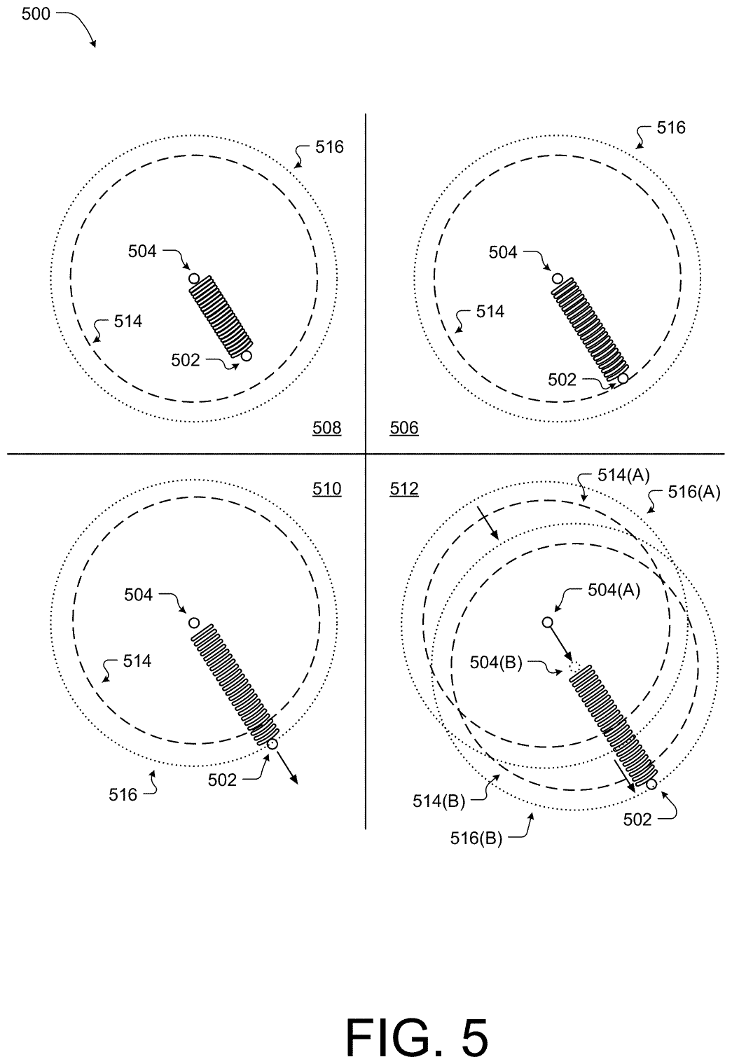

As discussed above and described in more detail below with respect to FIG. 5, in some cases, a safety feature may also be implemented. For example, if the virtual spring experiences excessive stretch (e.g. if the robotic arm deviates excessively from the desired path), then t stops incrementing every loop iteration and the trajectory motion is, thus, paused. In one implementation, the halting of the end-effector or impedance neutral position may be based on the following condition if: |X_{ref}−X_{act}|>SafeLimit. Thus, when the condition is true, the system limits the robotic system from applying additional or increased force by halting the trajectory motion of the impedance neutral position .

FIG. 5 illustrates an example pictorial diagram 500 of a model associated with the end-effector position, X_{act}, 502 and an impedance neutral position, X_{ref}, 504 according to some implementations. In the illustrated example, various distances between the end-effector position 502 and the impedance neutral position 504 as shown. As discussed above, if the virtual spring experiences excessive stretch then t stops incrementing every loop iteration and the trajectory motion is paused. Again, halting the end-effector position 502 or impedance neutral position 504 may be occur when the absolute value of the impedance neutral position 504 minus the end-effector position 502 (|X_{ref}−X_{act}|) is greater than a first safe limit 514. Thus, when the condition is true, the system limits the robotic arm from applying additional or increased force by halting the trajectory motion of the impedance neutral position 504 as shown in section 506. Once the conditions are false again (e.g., the spring becomes more compressed as shown in section 508), the trajectory motion is resumed (e.g., the impedance neutral position 504 is again moved along the trajectory). In some cases, the virtual spring stretch may become so excessive that the robotic system or end-effector has significantly deviated from an original or planned motion path. In these cases, the system may determine a new trajectory starting from a position between the end-effector position 502 and the current impedance neutral point 504(A). As one example, a condition for recalculating the trajectory may occur when the absolute value of the impedance neutral position 504 minus the end-effector position 502 (|X_{ref}−X_{act}|) is greater than a second safe limit 516. Thus, when the robotic system or end-effector is moved by an external force such that the virtual spring is stretched excessively (as shown in section 510), the endpoint of the spring that represents the impedance neutral point 504(A) (where spring stretch is zero) may be dragged in the direction of the end-effector (as shown by section 512) to create a new impedance neutral point 504(B) to maintain the limit of virtual spring stretch and a new motion trajectory or path may be determined. As a result, a new impedance neutral position 504(B), a new first safe limit 514(B), a new second safe limit 516(B) may be determined, and the new point 504(B) becomes the new Xₛₜₐᵣₜ in X_{ref}=Xₛₜₐᵣₜ+C₅ₜₕ(X_{tg}−Xₛₜₐᵣₜ) when the new trajectory is calculated. Once spring stretch is less than the new first safe limit 514(B), X_{ref} begins progressing along the new trajectory. As a result, the end-effector of the robot while moving toward a target position can be safely pushed away from its course in any direction by external disturbances from users or the environment and can calculate a new trajectory to complete the original task.

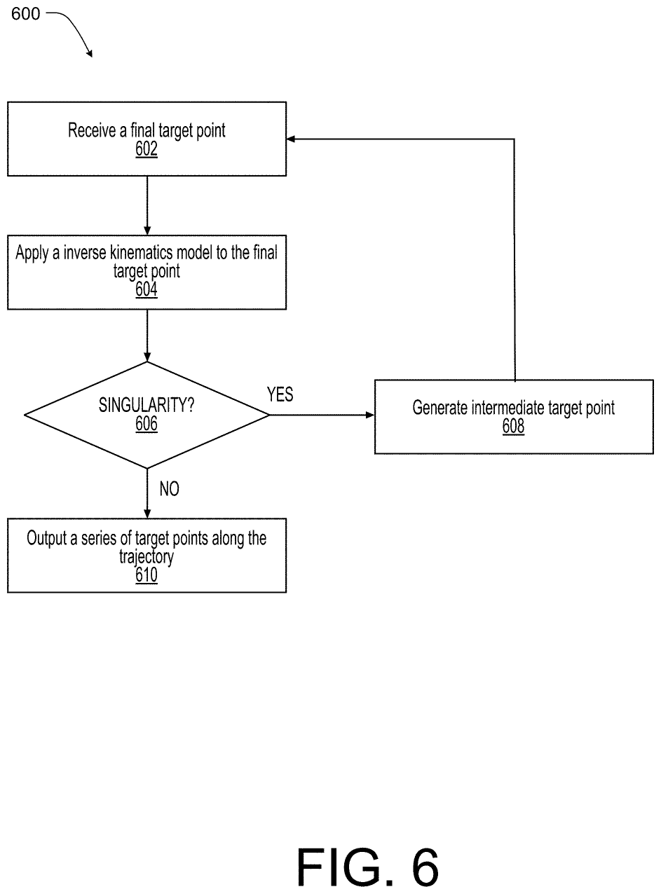

FIG. 6 is an example diagram illustrating an example process 600 for determining a target point associated with a motion path or trajectory as according to some implementations. As discussed above, the robotic system may utilize an impedance neutral position represented by a target point coupled to the actual position of the end-effector based on a model spring or dampening relationship.

At 602, the system may receive a final target point. In some cases, the target point may be updated by the trajectory generator for each cycle or segment of time based on the planned trajectory or motion path of the end-effector as well as the actual position of the end-effector, such as when the robotic system encounters situations shown in section 506 of FIG. 5 above.

At 604, the system may apply an inverse kinematics model to the target point. For example, inverse kinematics may be used to enable functionality to predict the robotic actuator angles in response to the desired positions and orientations of the actuators to affect the desired end pose by the end-effector. In the current example, the inputs to the inverse kinematics function include robot positions and orientations associated with the torque-controllable actuators and the output of the inverse kinematics function may be an array of joint angles that the robotic system would encounter at the final target point.

At 606, the system may determine if the robotic system includes a pose that is associated with a singularity. For example, in some specific designs, the robotic system may encounter a pose or poses that may have singularities (e.g., a pose at which two or more joint axes become parallel to each other or movement of one or more joints do not change the position of the end effector). In these specific designs, when a trajectory or motion path passes through or targets a pose at a singularity (e.g., an unsafe position and orientation of the robotic arm), the system may implement intervening action to ensure safe and smooth robot motion. For example, the robotic system may have a singularity position when the 4^{th} joint axis and 6^{th} joint axis from the base of the 6DOF arm are parallel each other. Thus, if the trajectory encounters a singularity, the process 600 may advance to 608. Otherwise the process 600, proceeds to 610 and outputs a series of intermediate target points along the trajectory to the trajectory generator.

At 608, the system may generate an intermediate target point. For example, the system may divide the trajectory into two independent trajectories. In this example, the first trajectory may include a joint rotation through the singularity pose to provide for a stabilizing joint-wise impedance. The second trajectory may include a remaining portion of the original trajectory. The remaining portion of the original trajectory (e.g., the second trajectory) may then be checked for any remaining singularities as the process 600 returns to 602.

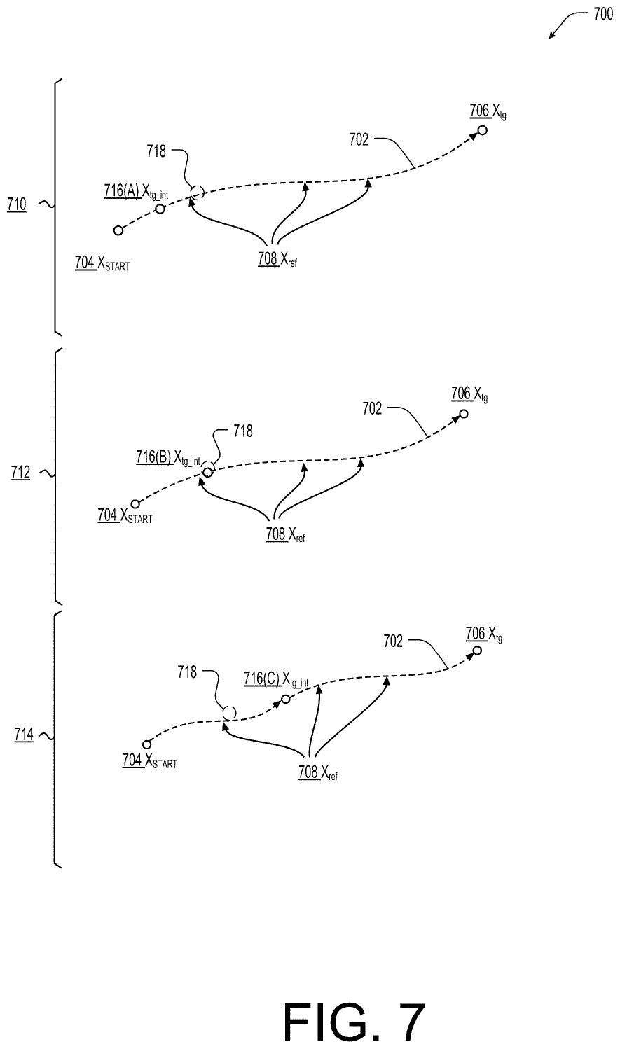

FIG. 7 illustrates a pictorial diagram 700 associated with the process 600 of FIG. 6 according to some implementations. For example, as discussed above, the trajectory 702 of the end-effector of the robotic system may include a start position, Xₛₜₐᵣₜ, 704, a target or end position, X_{tg}, 706, and a plurality of reference positions, X_{ref}, generally shown herein as 708. The illustrated example shows the trajectory 702 at three times, 710, 712, and 714 respectively. As discussed above with respect to FIG. 6, at a time 710, the trajectory generator may receive a target point 716 associated with the trajectory 702 and the trajectory generator may determine if a pose of the robotic system results in the robotic system passing through a singularity 718. In the illustrated example, the trajectory 702 intersects the singularity 718 at time 712. Thus, the trajectory generator may update the trajectory 702 to go around the singularity 718 (e.g., the pose at which one or more of the robot joints are colinearly aligned) as shown by the time 714.

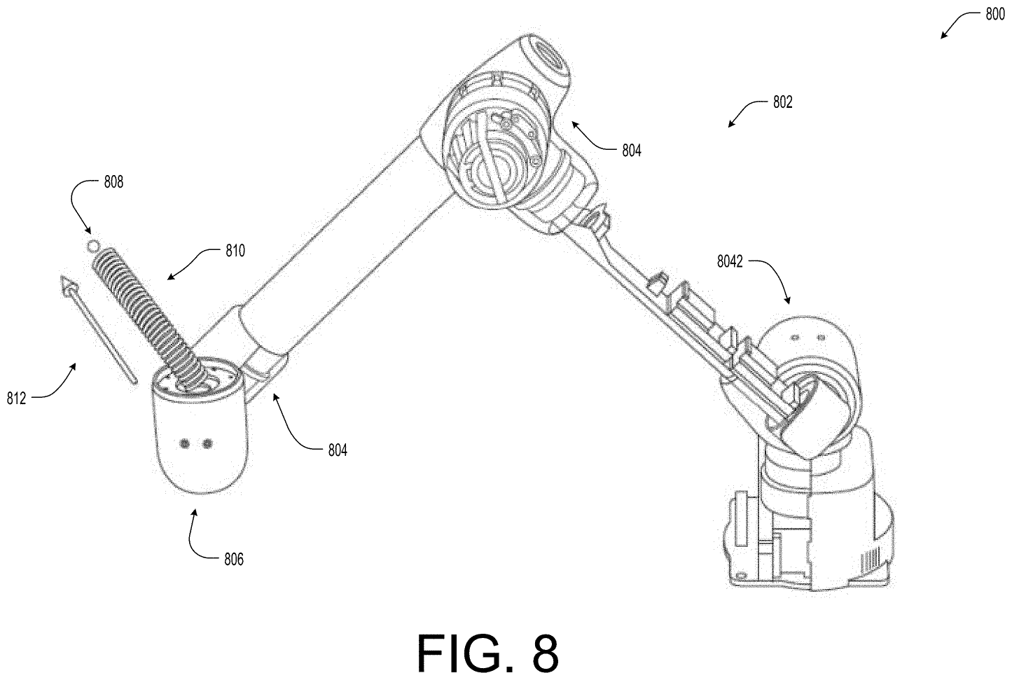

FIG. 8 illustrates an example pictorial diagram 800 of a robotic system 802 with torque-controllable actuators 804 controlling motion of an end-effector 806 based on an impedance neutral position 808 and an input impedance, generally illustrated as tensioned spring 810, according to some implementations. In the illustrated example, the end-effector 806 is pulled towards the impedance neutral position 808 in the direction 812 with a force based at least in part on the impedance 810.

For example, the impedance controller of the task planner component may receive a desired position and orientation of the torque-controllable actuators 804 with respect to a robot workspace domain. The impedance controller may convert the actual positions and orientations into a force and torque associated with the robot workspace that is useable to control the robotic system to the desired position and orientation. In this example, the impedance control is modeled as a virtual spring 810 that pulls the end-effector 806 to a desired impedance neutral position (or pose) 808. As discussed above, damping is also added to the model to prevent overshooting and smooth out the robot motion. Thus, the resulting impedance force by be represented as follows:

Fᵢₘₚ=kₛₚᵣ(X_{ref}−X_{act})−k_{damp}V_{act}

where Fᵢₘₚ is the force and torque required for an end-effector 706 to generate a desired impedance behavior 810. This impedance force may be added to the robot dynamics compensation model that eliminates a weight of the robotic system due to gravity, as well as at least partially eliminates inertial and Coriolis effects of the robot linkages with an effect of the impedance force acting on a weightless robotic arm and end-effector 806 with reduced inertia. Thus, the accuracy of the impedance-based position control may depend on a fidelity of robotics' force control which is determined by the preciseness of actuator's torque-control and the feedforward torque calculation that compensates for dynamic and static forces of the robotic system 802.

The feedforward control input may be determined from an inverse dynamics model of the target robotic system 802 which determines torque values required to follow a desired trajectory or motion path overcoming the dynamic and static forces generated by the inherent characteristics of the robotic system 802. The inverse dynamics may consider kinematic data as input parameters received from an inverse kinematic model that converts the task-space position to respective robotic joint angles.

The control torque input, τ_{cmd}, includes a feedforward torque, τ_{ff}, to improve the fidelity of the robotic system 802 by compensating for at least a portion of the forces caused by the inherent dynamics of the robotic system 802 including robot's own weight. In the current example, the feedforward torque, τ_{ff}, may be represented as follows:

τ_{ff}=M′(θ_{act})α_{des}+C′(θ_{act}, ω_{des})+G′(θ_{act})

In the current example, the feedforward torque in equation may be determined from an inverse dynamics model with an estimated robot inertia matrix, M′, estimated centrifugal and Coriolis force with velocity related force such as damping, C′, and estimated gravity force, G′. In some cases, a current angular position (θ_{act}), desired velocity (ω_{des}), and desired acceleration (α_{des}) of robot joints are used as input parameters to the inverse dynamics model. The desired velocity and acceleration may be determined from an inverse kinematics model with a given trajectory of the end-effector 706. If the robotic system 802 is commanded to generate force or impedance without a specific trajectory, the robotic system 802 may exhibit arbitrary movements depending on interaction with the environment. In some cases, an actual angular position with zero velocity and acceleration may be provided to the inverse dynamics model to assist in compensating for a gravity force associated with the robotic system 802. In some instances, an acceleration and velocity may be estimated from the actual angular position. In this case, a part of the inertial, centrifugal and Coriolis forces may be compensated for using the following equation:

τ_{ff}=K_{c}(M′(θ_{act})αₑₛₜ+C′(θ_{act}, ωₑₛₜ))+G′(θ_{act})

where K_{c} is a coefficient between 0 and 1, in one implementation, or, in another implementation, between 0 and 0.3.

In embodiments using the feedforward torque, the robotic system 702 with torque-controllable actuators 704 may generate workspace force and moment at the end-effector 706 in a high fidelity. For instance, the force F may refer to a set of force and moment described as follows:

F=[f^{T}m^{T}]^{T}

Where, f and m are the force and moment vectors and superscript ‘T’ refers to vector transpose.

In some instances, to generate a workspace force, Fₜₛₖ, a torque vector, τₜₛₖ is generated from the force by using a transpose of Jacobian matrix, J(θ), as shown above. The transpose may be added to the control torque input, τ_{cmd}, as follows:

τₜₛₖ=J(θ)^{T}Fₜₛₖ

Then, a set of Cartesian forces may be added and provided to the force controller component. For example, task force Fₜₛₖ may be the sum of a force to generate a desired impedance behavior, Fᵢₘₚ, an additional force needed for completing tasks, and a constraining force for bounding a safe workspace. The additional force, F_{add}, may be an upward force to compensate the weight of an object that the end-effector 806 may carry or grasp.

Fₜₛₖ=Fᵢₘₚ+F_{add}+F_{cst}

In some cases, to prevent the end-effector 806 from trespassing a workspace bound that may define an allowable workspace area for safety, a constraining workspace force, F_{cst}, may be added to the task force. For example, a workspace boundary may be defined as a sphere or a combination of planes. If the end-effector 806 trespasses the bounded surface, then the constraint force is constituted based on a workspace impedance rule as follows:

F_{cst}=K_{Wcst}(X_{closestpoint}−X_{act})−D_{Wcst}V_{act} if X_{act} tresspassed the workspace boundry

where, K_{Wcst} and D_{Wcst} are stiffness and damping matrices, respectively. X_{act} is the actual workspace position of the end-effector 806, and X_{closestpoint} is a point on the bounded surface that is closest to the actual position of the end-effector 706. In some cases, V_{act} are the workspace velocity of the end-effector 806.

In some cases, the robotic control system may add a joint-level constraint for a joint-level safety. For instance, additional torque, τ_{cst}, may be added to the final torque command and the constraint torque, τ_{cst}, can be constituted based on a joint-wise impedance as follows:

τ_{cst}=K_{Jcst}(θₘₐₓ−θ_{act})−D_{Jcst}ω_{act} if θ_{act}>θₘₐₓ

τ_{cst}=K_{Jcst}(θₘᵢₙ−θ_{act})−D_{Jcst}ω_{act} if θ_{act}<θₘᵢₙ

where, K_{Jcst} and D_{Jcst} are diagonal matrices filled with joint-wise stiffness and damping coefficients, respectively. θₘₐₓ and θₘᵢₙ are vectors of maximum and minimum allowable joint angles, respectively. θ_{act} and ω_{act} are vectors of actual joint angle and velocity, respectively. Thus, the feedforward torque, task torque, and constraint torque may be added to command the torque-controllable actuators 704 to produce intended workspace force and moment at the end-effector 706. The final torque command may be represented as follows:

τ_{cmd}=τ_{ff}+τₜₛₖ+τ_{cst}

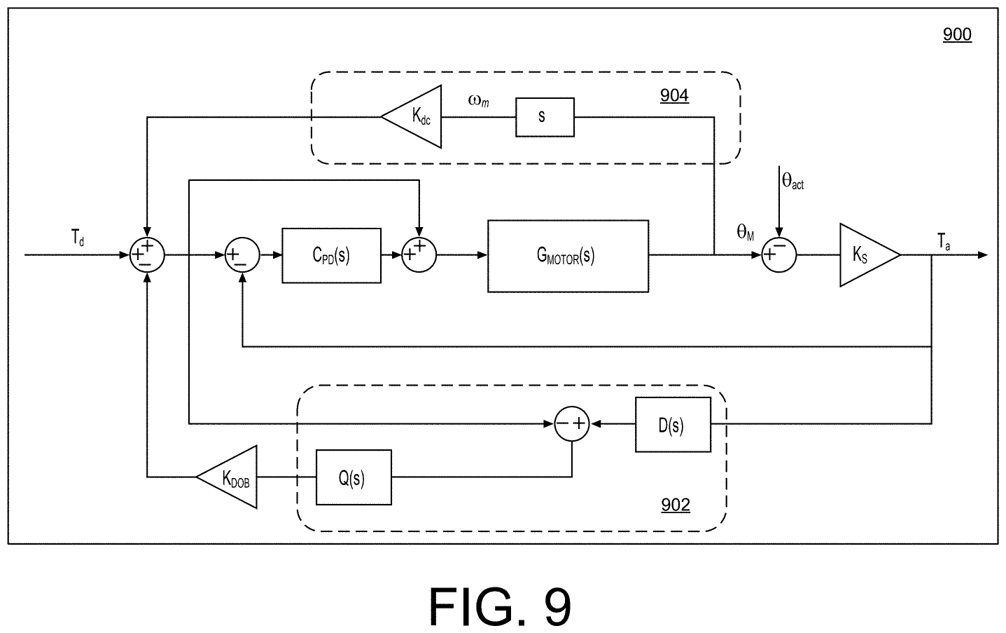

FIG. 9 illustrates an example actuator torque controller 900 according to some implementations. As discussed above, the robotic system may include one or more actuator torque controllers 900 associated with controlling the torque-controllable actuators based on the commanded torque, τ_{cmd}, received from the force control component. For example, the torque-controllable actuators may have a control input in a form of an electric current or voltage and sensor outputs including torque measurement at the actuator output. Thus, the actuators may receive the command input (e.g., the torque command) from the force controller component and produce a commanded torque at the actuator output.

A disturbance-observer component 902 may be used to increase the performance of the torque controller by removing the effects of unmodeled actuator phenomena such as static friction. In some cases, the disturbance-observer inverse dynamics component, D(s), may be simplified to 1 to reduce software complexity at little cost to performance. In this case the disturbance-observer reduces the steady-state error. The controller 900 may also include a damping friction compensation component 904 that counteracts a resultant damping-like behavior of the closed-loop system at the free-end condition by adding compensation torque to the desired torque, T_{d}.

The control process of the controller 900 may determine the actuator output torque by comparing the requested actuator torque from the force control component to an actual actuator torque measured by a torque sensor. The output of the controller 900 may be a requested current to the motor (e.g., a low-level current controller that executes sequentially). The actual actuator torque sensor feedback is filtered via a three-point median filter before being scaled into an actual torque value as follows:

Tₐ=T_{filtered3ptmed}(k)=median(T(k),T(k−1),T(k−2))

where Tₐ is the actual feedback torque, T_{filtered3ptmed}(k) is the three-point-median-filtered torque at the current iteration, T(k) is the current raw value of the torque, T(k−1) is raw torque from the previous iteration, and T(k−2) is the raw torque from two iterations previous. A three-point median filter may remove any single data points that are anomalous. The disturbance-observer component 802 receives the difference between the reference torque, T_{ref}, and the actual torque, Tₐ, and generates a disturbance-observer torque, T_{dob}, as follows:

T_{dob}=k_{dob}Q(s)(Tₐ−T_{ref})

where Q(s) represents a low-pass filter, and k_{dob} is a scaling factor in the range of [0,1]. The filter may be of the form: Q(s)=N_{f}/(N_{f}+s), where N_{f} is the cutoff frequency. The discrete form of this filter may be in the form: T_{f}=αT_{raw}(k)+(1−α)T_{f}(k−1) where α=N_{f}Tₛ/(N_{f}Tₛ+1), and Tₛ is the sampling period.

In the current example, T_{f} is the filtered output of the filter, and T_{raw}(k), T_{f}(k−1) represent the current iteration's raw value, and previous iteration's filtered value, respectively. Before the desired torque T_{d} is provided to the controller 800, the desired torque is adjusted by a closed-loop damping compensation, T_{dampcomp}, and the disturbance-observer torque, T_{dob}, as follows:

T_{ref}=T_{d}−T_{dampcomp}−T_{dob}

The error term that is input to the controller 900 may be the difference between the adjusted torque reference and the actual measured torque as follows:

E=T_{ref}−Tₐ

The derivative portion of the controller 900 also uses the same first-order filter. Thus, the controller is of the form: C_{PD}(s)=Kₚ+N_{f}/(N_{f}+s)K_{d}s, where Kₚ is the proportional gain, K_{d} is the derivative gain, and N_{f} is the low-pass filter cutoff frequency of the derivative calculation. After which, a feedforward term is added as follows: T_{motorFF}=T_{ref}.

The final output of the controller 900 to the motor of the actuator is a current command as follows:

Aₘₒₜₒᵣ=(1/(K_{τ}N_{gear}))(T_{motorFF}+T_{PD})=(1/(K_{τ}N_{gear}))(T_{d}+T_{dampcomp}−Q(s)(T_{α}−T_{ref})−E(s)C_{PD}(s))

where K_{τ} is the motor torque constant, N_{gear} is the actuator gear reduction ratio, and T_{PD} is the output torque of the controller 900.

For the damping compensation terms, as well as robot-level dynamics, the actuator angle, velocity, and accelerations are determined on the actuator controller 900 as follows:

θ_{act}=θ_{M}/N_{gear}+θ_{TMD}

The actuator angle, θ_{act} is simply the sum of the motor angle θ_{M} divided by the gear ratio N_{gear} and θ_{TMD} deflection of the torque measuring device. The actuator velocity is determined based on successive angle measurements and dividing by the sampling period, with a first-order filter as follows:

ω_{raw}(k)=(θ_{act}(k)−θ_{act}(k−1))/Tₛ

ω_{flt}(k)=αω_{raw}(k)+(1−α)ω_{flt}(k−1) where α=N_{f}Tₛ/(N_{f}Tₛ+1)

where ω_{raw}(k) is the raw angular velocity, θ_{act}(k) and θ_{act}(k−1) are the current and previous iteration's actuator angles respectively, Tₛ is the sampling period, ω_{flt}(k) and ω_{flt}(k−1) are the filtered angular velocities for the current and previous iterations respectively, and N_{f} is the low-pass filter cutoff frequency. This angular velocity is used to determine the damping compensation term T_{dampcomp} in the controller as follows:

T_{dampcomp}=k_{dc}ω_{flt}

where k_{dc} is a scaling factor to convert angular velocity to torque.

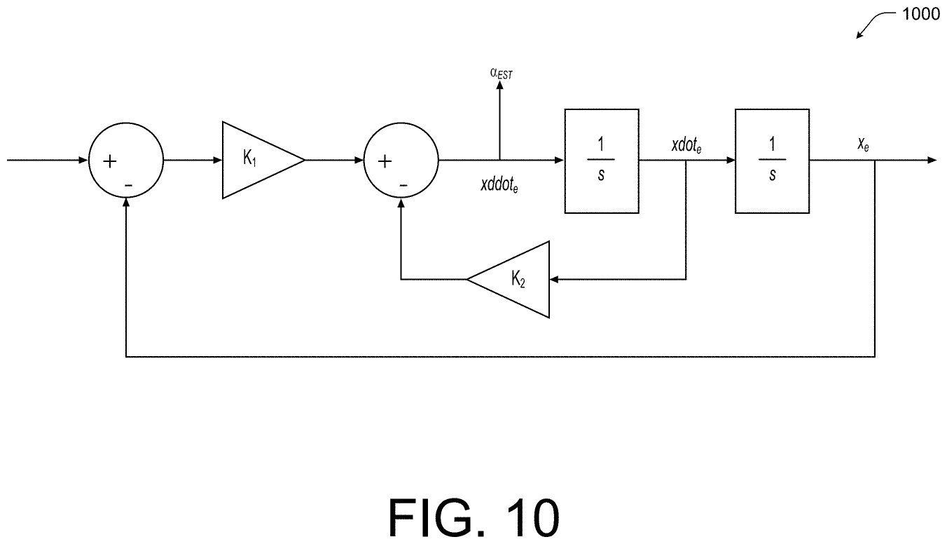

FIG. 10 illustrates an example acceleration estimator 1000 according to some implementations. For example, the acceleration estimator 1000 may be used to provide the desired velocity, ω_{des}, and desired acceleration, α_{des}, to the inverse dynamics model as discussed above with respect to FIG. 3. In the current example, the acceleration determined by the acceleration estimator 1000 produces a cleaner acceleration value, αₑₛₜ, with less lag than conventional filters.

For example, if x is the actual actuator position, xₑ is the estimated actuator position, and xdotₑ is the estimated actuator velocity, and: K₁=ω_{b}², K₂=ζω_{b} where ω_{b} is the cutoff frequency, and ζ=0.707. The difference form of the estimator may be determined as follows:

αₑ(k)=K₁(x−xₑ(k−1))−K₂xdotₑ(k−1)

edotₑ(k)=Tₛaₑ(k)+xdotₑ(k−1)

xₑ(k)=Tₛxdotₑ(k)+xₑ(k−1)

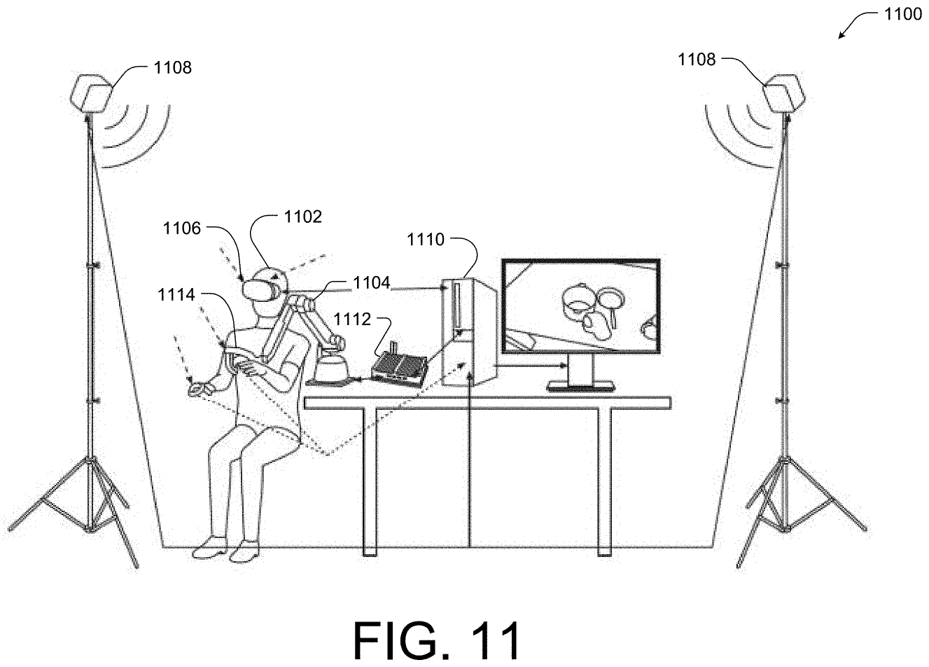

FIG. 11 illustrates an example pictorial diagram 1100 of a user 1102 utilizing the robotic system 1104 with respect to a virtual or mixed reality environment assembly according to some implementations. For example, utilizing virtual reality simulation in conjunction to the robotic system 114, discussed herein, may be used to improve training in the areas, for example, of employee skill training and patient rehabilitation. Thus, the diagram 1100 illustrates the user 1102, such as a surgical student, engaged in virtual reality training with respect to a surgical operation. In this example, the virtual reality system including the display 1106, the audio devices 1108, and the electric system 1110 may generate a virtual experience for the user 1102 in which the user 1102 may visually and auditorily consume the virtual environment. However, when training for tasks, such as a surgical operation, that require the user 1102 to train muscle memory and experience physical force-based feedback, the virtual reality system may be coupled to the control system 1112 of the robotic system 1104, as illustrated.

In this example, the user 1102 may manipulate the end-effector 1114 as the user 1102 moves their hand through the virtual environment. The control system 1112 may receive data associated with a virtual object that is encountered by the user 1102 within the virtual environment and generate a desired velocity, ω_{des}, and desired acceleration, α_{des}, for the robotic system 1104 to replicate a physical force acting on the hand of the user 1102 at the end-effector 1114 of the robotic system 1104. In other words, the control system 1112 causes the robotic system 1104 to generate a force replicating the user encountering the obstruction in the physical environment. Thus, a critical piece of realistic simulation may be provided by the robotic system 1104. For example, when the user 1102 lifts a virtual object, the end-effector 1114 presses down on the hand of the user 1102, so that the user 1102 feels the object's weight. In one example, the end-effector 1114 is equipped with a position tracker be that communicates with the electronic system 1110 and system controller 1112 to generate a position and orientation in the virtual scene. In some cases, the electronic system 1110 and system controller 1112 are integrated into the display 1106.

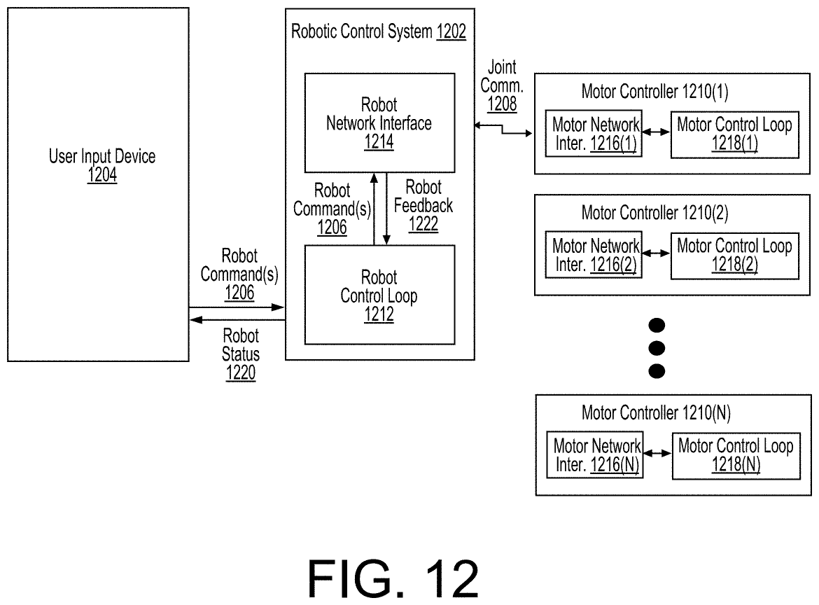

FIG. 12 illustrates an example architecture 1200 associated with the robotic system of FIG. 1 according to some implementations. For example, as discussed above, a robotic control system 1202 may also be coupled to user input device 1204, such as a personals computer or portable electronic device, for receiving robot commands 1206. The robot commands 1206 may include a desired motion, such as a trajectory and one or more tasks along the path and an impedance (or stiffness, dampening coefficient, etc.) associated with the virtual spring.

The robotic control system 1202 may be configured to receive the robot commands 1206 together with joint communication 1208 from one or more motor controllers 1210 of the torque-controllable actuators. In some cases, the robotic control system 1202 may also provide robot status 1220 back to the user device 1204. For example, as illustrated, the data flow may commence with a desired robot trajectory or workspace (expressed in a robot's global Cartesian coordinate system) force of the end-effector of a robot from the user device 1204, as the robot command. The robotic control system 1202 may then convert the workspace forces into actuator torques via the robot control loop 1218 based on the robot commands 1206 and feedback 1222 from the motor controllers 1210. The actuator torques may then be communicated as joint communication 1208 to the cascaded motor control loops 1218 over a network via the interfaces 1214 and 1216. The motor control loop 1218 on each actuator converts the desired torque into motor commands for execution.

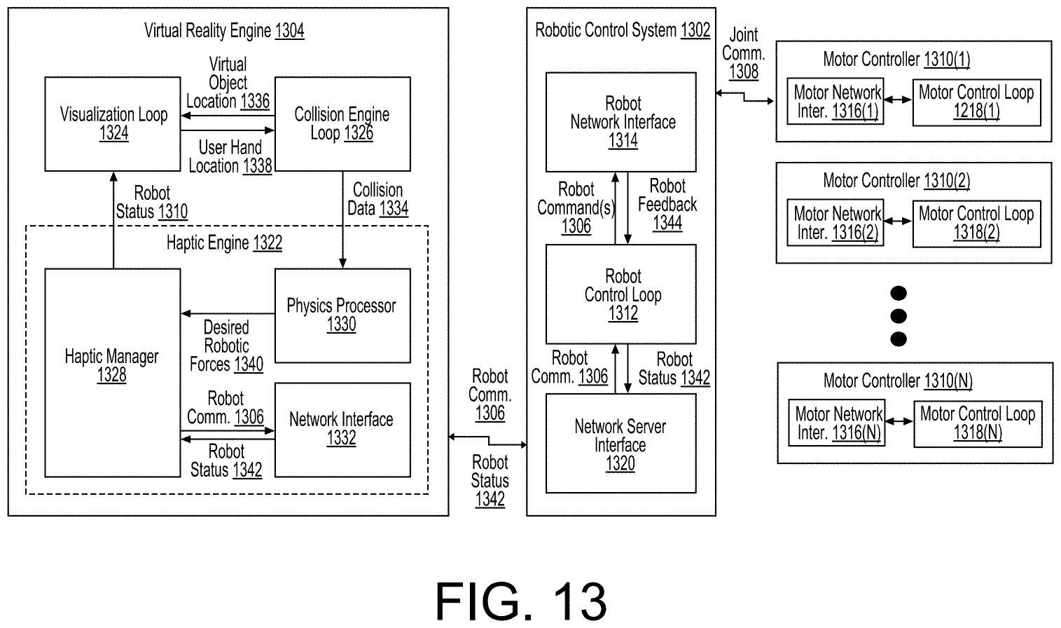

FIG. 13 illustrates an example architecture 1300 associated with the robotic system of FIG. 11 according to some implementations. Similar to the architecture 1200 shown above, the architecture 1300 utilizes a robotic control system 1302 in communication with one or more motor controllers 1310 via a network using joint communication 1308 and network interfaces 1314 and 1316, respectively. Again, the actuator torques may then be communicated as joint communication 1308 to the motor control loop 1318 on each actuator may convert the desired torque into motor commands for execution.

In this example, the robotic control system 1302 may include the robot network interface 1314 and the robot control loop 1312 which communicate the robot commands 1306 and the robot feedback 1344 similar to FIG. 12. However, in this example, the robotic control system 1302 also includes a network server interface 1320 and the user device has been replaced with virtual reality engine 1304. In this example, the virtual reality engine 1304 may determine the forces and torques based on a co-located position of the user and the end-effector. The forces and torques are recovered from a haptic engine 1322 and transmitted via a network interface 1332 to the robotic control system 1302, which renders the physical sensation by generating forces and torques at the user-interaction point (e.g., the end-effector) on the robotic system. In some cases, to determine if the end-effector collides with a virtual object, the virtual reality engine 1304 may utilize a visualization loop 1324, a collision engine loop 1326, as well as a haptic manager 1328, and physics processor 1330. For example, the visualization loop 1324 and the collision engine loop 1326 may determine collision data 1334 based on a location of the virtual object 1336 and a location of the user hand 1338 (e.g., the location of the end-effector). The collision data 1334 is provided to the physics processor 1330 which in turn generates desired robotic forces 1340. The desired robotic forces 1340 are then processed by the haptic manger 1328 with the robot status 1342 which outputs the robot commands 1306.

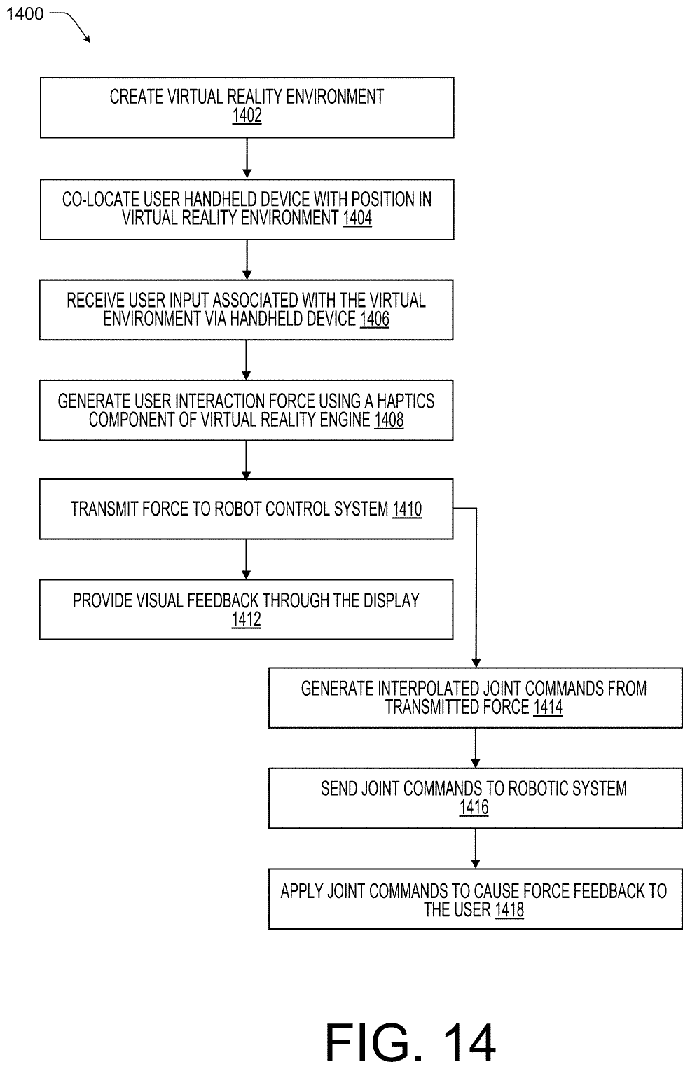

FIG. 14 illustrates an example diagram illustrating an example process 1400 for determining feedback force associated with a virtual or mixed reality environment according to some implementations. As discussed above, the robotic system may be utilized in conjunction with a virtual or mixed reality system, such as a system for force skill-based training. In these examples, the robotic system may be used to replicate forces associated with physics-based interactions within the virtual environment in a physical and meaningful way.

At 1402, the system may generate a virtual reality (or mixed reality) environment. For example, the system may cause a three-dimensional virtual reality to be displayed to a user via a headset system. In some cases, the system may output audio, including directionally, associated with the source of the audio within the virtual environment.

At 1404, the system may co-locate the user handheld device (e.g., the end-effector) with a position in the virtual reality environment. For example, the end-effector may be equipped with a position sensor that may provide feedback to the system in a manner in which the system may determine a pose and/or position of the end-effector. In some cases, the sensor may provide a six-degree of freedom pose associated with the position of the user's hand and the virtual environment.

At 1406, the system may receive a user input associated with the virtual environment via the handheld device. For example, the user may operate or move the pose of the end-effector to simulate a movement of the user's hand through the virtual environment.

At 1408, the system may generate user interaction force using a haptics component of the virtual reality engine. For example, the system may utilize one or more collision engines to determine an intersection between the user's hand and a virtual object and a physics processor to determine desired robotic forces based at least in part on the collision data. A haptic manager may then determine a transmitted force to control the torque or force associated with the end-effector based at least in part on the desired robotic forces.

At 1410, the system may transmit the commanded force to the robotic control system. For example, the virtual reality engine may communicate to the robotic control system via one or more network loops.

At 1412, the system may provide visual feedback through the display. For example, the display may show the user holding or pushing or otherwise interacting with an object in the virtual environment.

At 1414, the system may generate interpolated joint commands from the transmitted force. For example, a robotic control system may be configured to receive the transmitted force and to translate the force into a torque commands for each of the torque-controllable actuators of the robotic system. In some cases, the interpolated joint commands may be based at least in part on feedback received from the torque-controllable actuators and/or a safety threshold.

At 1416, the system may send the joint commands to the robotic system and, at 1418, the robotic system may apply the joint commands to cause force feedback to the user. For example, the user may experience force feedback that replicates the weight of the object being held as the end-effector pushes or pulls downward on the hand of the user.

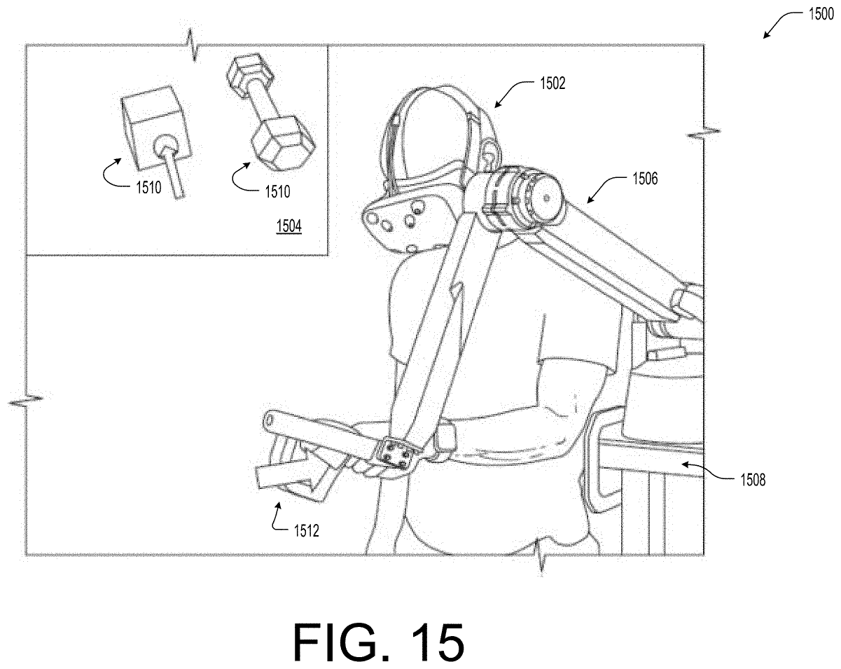

FIG. 15 illustrates another example pictorial diagram of a user utilizing the robotic system with respect to a virtual or mixed reality environment according to some implementations. For instance, in the current example, the user 1502 is immersed in a virtual environment 1504 via sight as shown. In this example, as shown, a few interactable objects 1510 are within the virtual environment 1504. In this example, in addition to experiencing the visual feedback the user may feel physical feedback from the robotic system 1506. As shown, the robotic system 1506 is coupled to an immovable tabletop 1508 to prevent the user 1502 from moving the robotic system 1506 during use. While interacting with the object 1510, a user can introduce a force, such as a lifting force or a pushing force on the objects 510 by adjusting the end-effector 1512 of the robotic system 1506. Likewise, the robotic system 1506 may also provide feedback to the user via a counter force, such as a weight, of the objects 1510 being applied to the hand of the user via the end-effector 1512 as the user manipulates the virtual objects 1510.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A robotic system comprising:
a robotic arm, the robotic arm including a plurality of torque-controllable joints and an end-effector;
a plurality of actuator control systems, individual actuator control systems of the plurality of actuator control systems coupled to individual joints of the plurality of torque-controllable joints to control the operations of the plurality of torque-controllable joints based on a torque command signal; and
a robotic control system coupled to the plurality of actuator control systems, the robotic control system to generate the torque command signal based on a position and orientation of the end-effector and a desired impedance.

2. The robotic system as recited in claim 1, wherein the robotic control system includes a task planner component to determine a trajectory associated with the end-effector based at least in part on a start position, at least one intermediate position, and an end position.

3. The robotic system as recited in claim 2, wherein the task planner component updates the trajectory associated with the end-effector to avoid at least one singularity.

4. The robotic system as recited in claim 2, wherein the task planner determines the trajectory based at least in part on an inverse kinematics model.

5. The robotic system as recited in claim 1, wherein the robotic control system determines the torque command based at least in part on task-related workspace force and a feedforward torque.

6. The robotic system as recited in claim 5, wherein the task-related workspace force is determined based at least in part on a spring-damping force and a safety force.

7. The robotic system as recited in claim 5, wherein the feedforward torque is based at least in part on an inverse dynamics model, an reference position of the end-effector, desired velocity of the end-effector, and a desired acceleration of the end-effector.

8. The robotic system as recited in claim 1, wherein the desired impedance is received from a user device.

9. A method comprising:
receiving a desired stiffness from a user device;
determining a spring-damping force based at least in part on the desired stiffness and a reference position associated with an end-effector of a robotic arm, the robotic arm having at least two torque-controllable joints;
determining a task-related workspace force based at least in part on the spring-damping force and at least one additional force value;
determining a torque vector based at least in part on the task-related workspace force;
determining a torque command based at least in the torque vector and a feedforward torque; and
sending the torque command to the at least two torque-controllable joints.

10. The method of claim 9, wherein the additional force value represents a safety force.

11. The method of claim 9, wherein the additional force value represents a physical force acting on the end-effector.

12. The method of claim 9, wherein the at least two torque-controllable joints each have a corresponding torque-controlled actuator and torque controller, wherein sending the torque command to the at least two torque-controllable joints comprise sending the torque command to the torque controllers.

13. The method of claim 12, further comprising receiving actuator data from a sensor associated with the at least two torque-controllable joints and wherein the desired velocity of the end-effector and the desired acceleration of the end-effector are determined based at least in part on the actuator data.

14. The method of claim 12, wherein the desired velocity of the end-effector and the desired acceleration of the end-effector are received from a trajectory generator component.

15. The method of claim 9, wherein the spring-damping force is based at least in part on a desired position of the end-effector and an actual position of the end-effector.

16. A method comprising:
receiving a desired stiffness from a user device;
determining a trajectory associated with an impedance neutral point;
determining a task-related workspace force based at least in part on the desired stiffness, a first position of the impedance neutral point, and a first position of an end-effector of a robotic arm;
determining a torque command based at least in part on the task-related workspace force; and
sending the torque command to an actuator control system associated with the robotic arm.

17. The method of claim 16, wherein the task-related workspace force is also based at least in part on a safety force threshold.

18. The method of claim 16, further comprising:
determining an absolute value of a difference between the first position of the impedance neutral point and the first position of the end-effector is greater than a threshold distance;
adjusting, based at least in part on determining the difference is greater than the threshold distance, the first position of the impedance natural point to a second position, the second position closer in proximity to the first position of the end-effector than the first position of the impedance natural point.

19. The method of claim 16, wherein the robotic arm includes a plurality of torque-controllable actuators.

20. The method of claim 16, wherein task-related workspace force is based at least in part on a distance between the first position of the impedance neutral point and the first position of the end-effector.
